(19) United States
(12) Patent Application Publication
(10) Pub. No.: US 2003/0103075 A1
(43) Pub. Date: Jun. 5, 2003

(54) System and method for control of conference facilities and equipment

(76) Inventor: Robert Charles Rosselot, Guilford, IN (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/004,904

(22) Filed: Dec. 3, 2001

(51) Int. Cl. G09G 5/00

(52) U.S. Cl. 345/717; 345/740

(57) ABSTRACT

A system and method for accessing conference room devices connected to a first computer include receiving status information from available devices connected to the first computer, displaying a device menu of available devices for a particular conference room, displaying a control menu to control a selected one of the available devices, and transmitting commands to the selected one of the available devices to control the device in response to user input. In one embodiment, the first computer is accessible via a web browser so a remote user can control or operate the conference room devices. The conference room devices may include facility devices, such as room lights, thermostat, door lock, drapes, etc. in addition to audio/visual equipment, such as VCR's, projectors, screens, and cameras, for example.

### TECHNICAL FIELD

The present invention relates to a system and method for remotely and locally controlling conference room facilities and equipment with a standardized user interface.

### BACKGROUND ART

The ever-changing and wide variety of audio, visual, and computer equipment and related conferencing facilities often intimidates the average user. Results range from less than optimal communication during a meeting or conference to complete avoidance of using equipment which would otherwise enhance a meeting. For many facilities, conference rooms may not be open or ready when users arrive, unless someone has prepared the room and/or equipment prior to the meeting. Users who attempt to use equipment must often select a proper remote control and then navigate a variety of non-intuitive user interfaces or menus to perform the most basic functions, such as turning power on, volume up or down, or playing or recording audio or video. Attempted use of unfamiliar equipment often results in delays and/or calls to technical support personnel. Problems which are not quickly resolved often require dispatching someone to the room, with the attendant additional delay. As such, proper use of available equipment and facilities is often difficult and intimidating to many people, and costly in terms of support. Valuable time and resources are lost in many conferences while room coordinators are being located, equipment power is being cycled, and help is being summoned.

### DISCLOSURE OF INVENTION

A system and method for controlling conference room devices connected to a first computer include displaying a type menu for selection of a type of conference, receiving status information from the devices connected to the first computer, displaying a device menu of available devices for a particular conference room corresponding to the type of conference selected, displaying a control menu to control a selected one of the available devices, and transmitting commands to the selected one of the available devices to control the device in response to user input. In one embodiment, the first computer is accessible via a web browser so a remote user can control or operate the conference room devices. The conference room devices may include facility devices, such as room lights, thermostat, door lock, drapes, etc. in addition to audio/visual equipment, such as VCR's, projectors, screens, and cameras, for example.

The present invention provides a number of advantages. For example, the present invention provides a standardized, intuitive user interface for local and/or remote control of commonly available conference room facilities and equipment. The user interface provides a departmentalized menu structure which is user friendly with tested usability. The ability to remotely control conference room devices reduces the need for on-site room coordinators and/or technical support personnel because support personnel can log in to a room to look at equipment status, cycle power, and monitor video output to diagnose and correct problems. An automatic equipment tracking feature allows support personnel to track life of various components and implement preventative maintenance. For example, email messages are automatically generated for non-urgent problems, such as light bulbs needing to be replaced before they burn out. Wireless communication via phone, pager, or other electronic devices may be provided for time-critical problems which require technical support. Accessibility of the local control computer via a web browser allows the standardized interface to control any device in any of the enabled conference rooms from virtually anywhere in the world. The present invention essentially removes the intimidating factors of operating unfamiliar equipment and may improve effectiveness and efficiency of local meetings as well as audio and video conferences.

The above advantages and other advantages, objects, and features of the present invention, will be readily apparent from the following detailed description of the best mode for carrying out the invention when taken in connection with the accompanying drawings.

### BRIEF DESCRIPTION OF DRAWINGS

FIG. 1 is a block diagram illustrating a representative configuration for a system for controlling conference room devices according to one embodiment of the present invention;

FIG. 2 illustrates a representative password screen for gaining remote access to control conference room devices according to one embodiment of the present invention;

FIG. 3 illustrates a representative main screen including a type menu for selection of a type of conference according to one embodiment of the present invention;

FIG. 4 illustrates a representative local conference screen having menus for controlling conference room devices associated with a local conference according to one embodiment of the present invention;

FIG. 5 illustrates a representative audio conference screen having menus for controlling conference room devices associated with an audio conference according to one embodiment of the present invention;

FIG. 6 illustrates a representative video conference screen having menus for controlling conference room devices associated with a video conference according to one embodiment of the present invention;

FIG. 7 illustrates a help submenu within a local conference menu according to one embodiment of the present invention;

FIG. 8 illustrates a representative video cassette recorder (VCR) control menu for locally or remotely controlling a VCR in a conference room according to one embodiment of the present invention;

FIG. 9 illustrates a representative digital video disk (DVD) control menu for locally or remotely controlling a DVD device according to one embodiment of the present invention;

FIG. 10 illustrates a representative compact disk (CD) control menu for locally or remotely controlling a CD device according to one embodiment of the present invention;

FIG. 11 illustrates a representative audio cassette control menu for locally or remotely controlling an audio cassette device according to one embodiment of the present invention;

FIG. 12 illustrates a representative document camera control menu for locally or remotely controlling a conference room camera according to one embodiment of the present invention;

FIG. 13 illustrates a representative auxiliary input control menu for locally or remotely controlling auxiliary equipment according to one embodiment of the present invention;

FIG. 14 illustrates a representative room lighting control menu for locally or remotely controlling ambient lighting in a conference room according to one embodiment of the present invention;

FIG. 15 illustrates a representative room set-up menu for locally or remotely controlling various conference room equipment according to one embodiment of the present invention;

FIG. 16 illustrates a representative computer output selection menu for locally or remotely controlling the display of a local computer's output according to one embodiment of the present invention;

FIG. 17 illustrates a representative camera preset control menu for locally or remotely controlling a videoconferencing camera according to one embodiment of the present invention;

FIG. 18 illustrates operation of a system or method for controlling conference room devices according to one embodiment of the present invention; and

FIG. 19 illustrates a representative configuration for remotely accessing conference room devices using a scheduler according to one embodiment of the present invention.

### BEST MODES FOR CARRYING OUT THE INVENTION

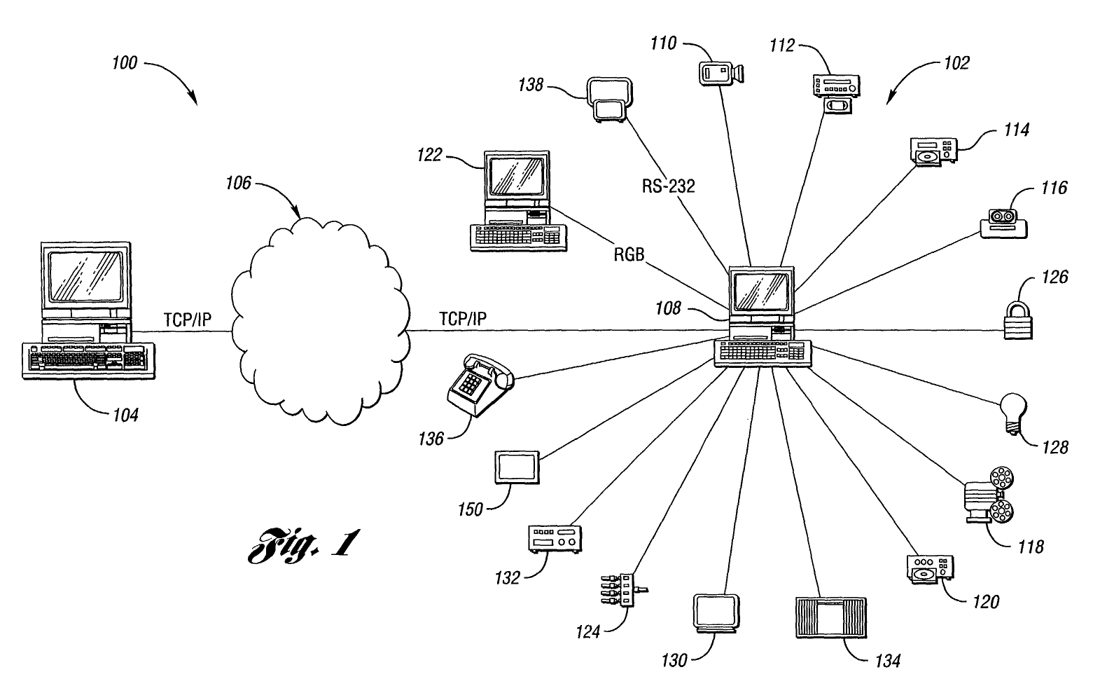

Referring now to FIG. 1, a block diagram illustrating a representative configuration for a system for controlling conference room devices according to one embodiment of the present invention is shown. System 100 includes a plurality of conference room devices 102 which may be remotely controllable using a computer 104 connected via a network indicated generally by reference numeral 106. A first computer 108 is preferably located within a meeting or conference room to facilitate direct connection to various conference room devices 102. Of course, depending upon the particular implementation, computer 108 may be located within a suitable distance of the conference room to accommodate direct connections based on the associated protocol used to communicate command and debit information. In one embodiment, computer 108 is directly connected to various conference room devices 102 using a two-way protocol, such as RS-232, Telnet, or application program interface calls (API's), for example.

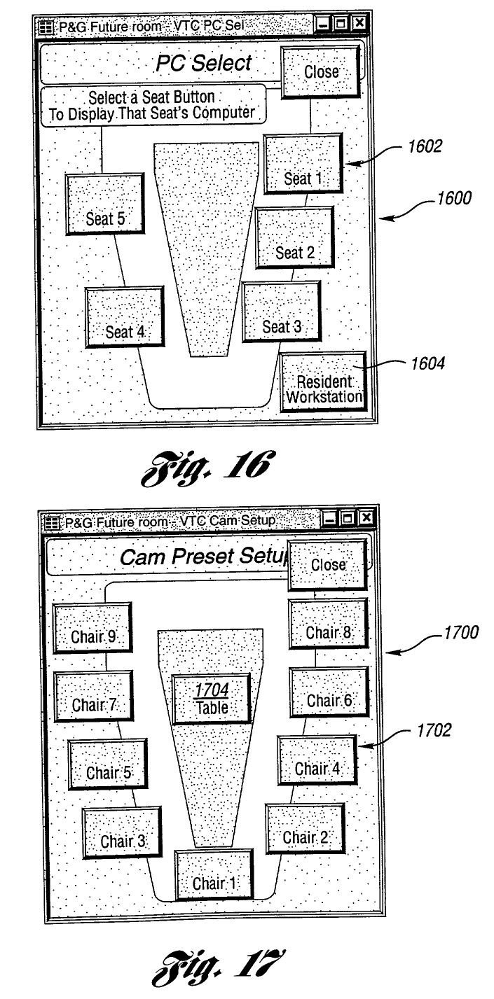

Conference room devices may include various types of audio/visual equipment in addition to devices used to control the ambient conditions of the meeting or conference room. For example, audio/visual equipment may include cameras 110, VCR 112, DVD 114, cassette player/recorder 116, projector 118, CD player 120, one or more local computers 122, and various auxiliary equipment 124. Conference room devices used to control the ambient conditions of the conference or meeting room may include access control devices such as door locks 126, room lights 128, a projector screen 130, audio speakers 132, window coverings such as blinds/drapes 134, a telephone 136, and an electronic white board 138, for example. Local control of the conference room devices is preferably provided via a standardized set of menus that form a graphical user interface displayed via a menu display and user input device 150, which may be a touch panel or similar system, for example. In one embodiment, device 150 is a touchless point screen that uses stereo camera technology to detect user gestures to select menu options displayed on a standard screen display, wall, etc. Such systems are available from JerterTek, In.c of New York, N.Y., for example. As described in greater detail with reference to FIGS. 1-15, touch panel 150 may be used to display a user interface with intuitive controls to control some or all of the functions of connected conference room devices 102. Alternatively, or in combination, remote control of one or more conference room devices may be provided by a remotely located computer 104 which communicates with conference room computer 108 via a computer network 106. In one embodiment, computer network 106 may include any of a number of local and wide area networks including the Internet. In this embodiment, the graphical user interface is preferably provided using HTML or a compatible language such that the control menus are accessible via a web browser.

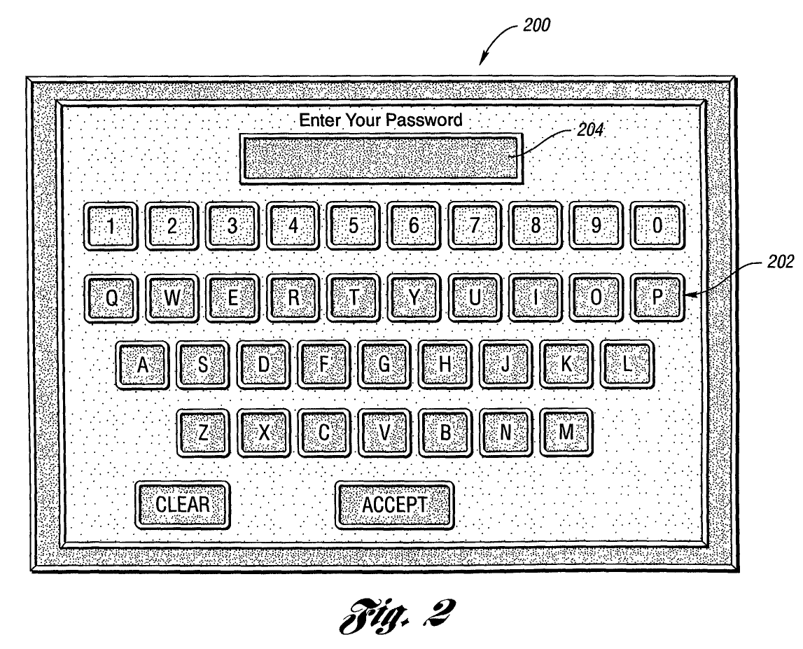

FIG. 2 illustrates a representative password screen for gaining remote access to control conference room devices according to one embodiment of the present invention. As described with reference to FIG. 1, the various menus illustrated in FIGS. 2-14 may be displayed locally via a dedicated touch panel in direct communication with a local computer and/or displayed remotely via appropriate software, such as a web browser, for example. In a representative remote control application, a remote computer accesses the local conference room computer using TCP/IP by entering the IP address of the local computer. While the illustrated embodiment utilizes a single local computer for each conference room, it is possible for a single local computer to control devices in multiple conference rooms if desired. Password screen 200 is displayed when a remote user enters the appropriate IP address or otherwise connects to a local conference room computer. The remote user must enter an appropriate password to gain access to view a conference room or control conference room devices for a particular room. Passwords may be entered using the illustrated keyboard 202 or by directly typing a password into the prompt window 204. The graphical presentation of keyboard 202 provides a common, standardized interface which can be displayed via either a dedicated touch panel or a remotely located web browser.

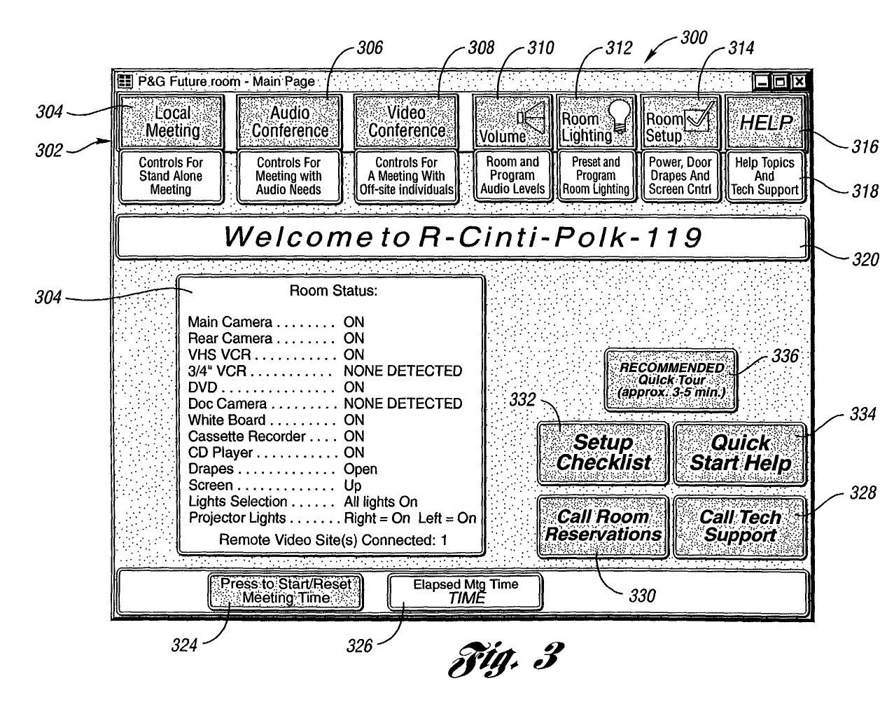

FIG. 3 illustrates a representative main screen including a type menu for selection of a type of conference according to one embodiment of the present invention. Main screen 300 preferably includes a type menu 302 for selection of a type of conference. In this example, type menu 302 includes selections for a local meeting 304, audio conference 306, and video conference 308. In addition, menus are provided to control ambient conditions of the conference room such as the volume 310, room lights 312, and room setup 314. In addition, menus are provided for help 316 and technical support 318.

As also illustrated in FIG. 3, the main screen preferably includes a banner 320 which identifies the particular conference or meeting room and may include a physical location as well as a network address or name identification. A summary block 322 displays the status of all conference room devices including equipment and devices to control ambient conditions. Various other buttons or menus may be provided to start/reset the meeting time 324 and to display the elapsed meeting time 326. In addition, buttons may be provided to call technical support 328, or call a room reservationist 330. In the embodiment illustrated in FIG. 3, buttons are also provided to access a setup check list 332 and to give a brief tutorial 334 or a more complete orientation 336. Button 336 may be used to provide a video tutorial to the user illustrating use of the various command menus.

The summary section 322 of the screen is dynamically updated so that users can immediately see if a device is available for use. A standardized screen such as illustrated in FIG. 3 allows all conference rooms to have the same interface which increases the comfort and reduces learning associated with use of various conference room devices. In addition, by displaying the available devices, the user is made aware of available equipment which he or she may use to enhance the present meeting or a future meeting. In addition, as described in greater detail below, because devices are automatically recognized by the system, equipment may be shared between available conference rooms, i.e. users can connect and disconnect devices without additional technical support intervention for setup, etc.

The representative menus illustrated provide conceptual departmentalization of various control aspects. For conferencing, the menu distinguishes between a local meeting 304, audio conference 306, and video conference 308. This departmentalization makes the system easier to use in that the user is presented with controls for only that equipment which may be needed for the selected type of meeting, without overwhelming the user with equipment that does not apply for the selected type of meeting (e.g. no camera controls are provided for a local meeting).

Referring now to FIG. 4, a representative local conference screen having menus for controlling conference room devices associated with a local conference according to one embodiment of the present invention is shown. The screen of FIG. 4 is displayed when a user selects local meeting 304 from the screen illustrated in FIG. 3. This screen allows the user to control equipment in a conference room for a local meeting, i.e. where all participants are in the same room. In the example illustrated in FIG. 4, two screens are provided in the conference room for display of outputs from various conference room devices. Menu 410 allows a user to select a device to display on a left screen while menu 412 allows a user to select a device to display on the right screen. For each conference room device associated with a local meeting as displayed in menus 410 and 412, a text description 414, and icon 416 are provided. The text description 414 and icon 416 are positioned on a select/preview button which selects the particular device for local display.

The interface preferably provides three kinds of visual feedback with respect to the status and/or availability of each device. Icons or buttons preferably change colors as the corresponding status changes from inactive to active. In addition, the main screen, illustrated in FIG. 2, displays an on/off status of all equipment. The automatic recognition of available and unavailable conference room devices “grays out” equipment that is not currently available so that it may not be selected. In addition, the video out display 420, preferably located in the middle of the screen, displays periodic snapshots of the output screen. For the dedicated touch panel, the video output screen is preferably updated in real-time, i.e thirty frames per second. For the remote web interface, the video display 420 may display at a slower frame rate to accommodate lower bandwidth availability or requirements for the remote connection. As also illustrated in FIG. 4, each conference room device preferably includes a separate send button 418 positioned next to the select/preview button. This feature allows a user to select a device, control or arrange the presets, que up tapes, adjust cameras, etc. while another device's output is going out on the video screen. The user selects the send button to transmit the outputs from the selected device. The send button then remains lighted to indicate which device is providing output for transmission. The video output display 420 will then display updated snapshots of the video screen.

Additional menu buttons may be provided as illustrated in FIG. 4. For example, menu button 400 returns from the local meeting menu to the main screen illustrated in FIG. 3. A user may select button 402 to record the meeting to a VCR while button 404 records the audio portion of the meeting to an audio cassette. As with the other menus illustrated to describe the present invention, various other buttons or controls may be provided depending upon the particular application.

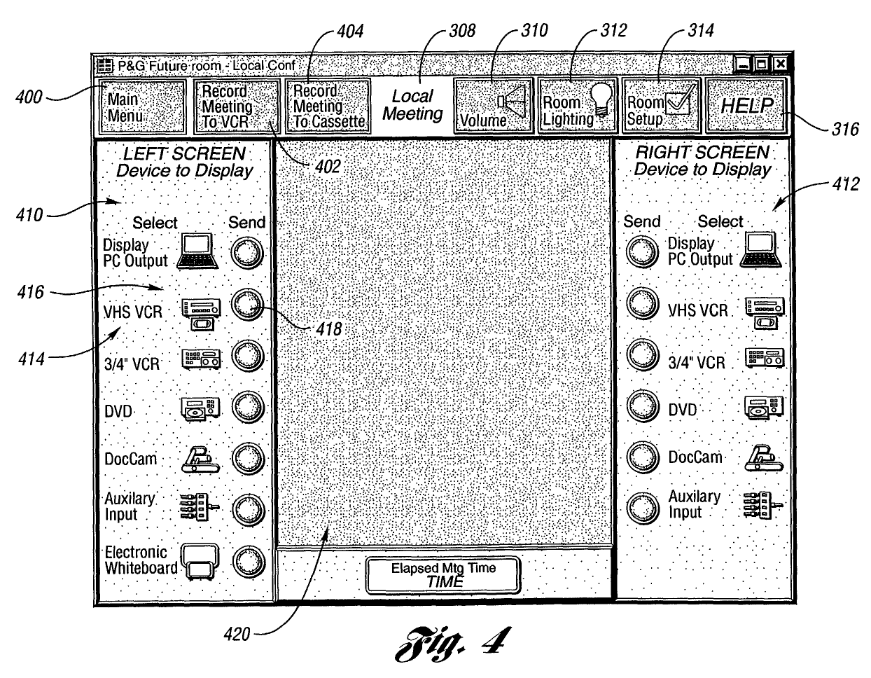

Referring now to FIG. 5, a representative audio conference screen having menus for controlling conference room devices associated with an audio conference according to one embodiment of the present invention is shown. Similar to the local meeting selection, once an audio conference is selected, corresponding menus are displayed which allow control of equipment associated with an audio conference. For example, a mute button 500 is provided to silence the audio output of a microphone or speaker phone in the room. A device menu 502 is provided illustrating available conference room devices. A telephone menu 504 is provided with cursor menu 506 and keypad 508, for example. In addition, an elapsed call timer 510 may be provided to track the total time of the conference call.

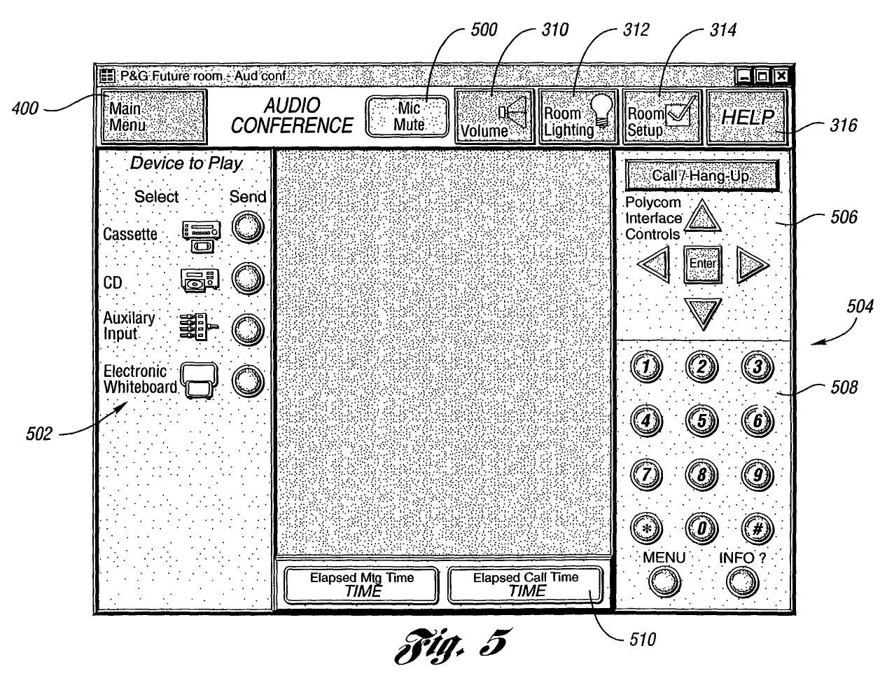

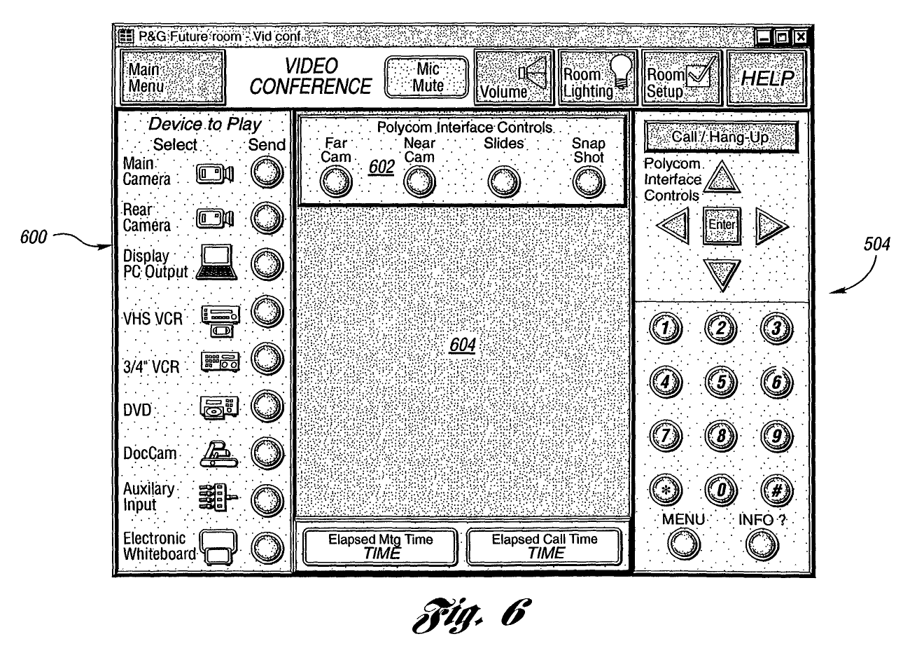

FIG. 6 illustrates a representative video conference screen having menus for controlling conference room devices associated with a video conference according to one embodiment of the present invention. Selecting a video conference from the main screen illustrated in FIG. 1 displays the video conference screen illustrated in FIG. 6. Similar to screens previously described, the video conference screen includes a menu 600 which allows local or remote control of all equipment available in the conference room. A camera menu 602 and phone menu 504 provide control of the video conferencing with the video output displayed in area 604. As described with reference to FIG. 4, a user can select a device to display and preview the output from the device in window 604. When the associated send button is pressed, the output will be transmitted to the remote destination of the video conference. The send button will then light to show which device is currently sending its output over the video screen. The video output display area 604 will periodically display snapshots of the video screen. Depending upon the bandwidth of the connection, this display may be real-time, i.e. 30 frames per second or more. Where bandwidth is limited, or real-time information is unnecessary, the video may be updated periodically, i.e. every few seconds. The video output display area 604 may also be used to display submenu screens as illustrated and described with reference to FIG. 7.

FIG. 7 illustrates a help submenu displayed within a local conference menu according to one embodiment of the present invention. Help submenu 700 is displayed within the context of the currently selected meeting type when the user selects the help button 316. The active submenu will overlay the video output until it is closed via a corresponding button or command 702. However, the elapsed meeting time 326 remains in the display, in addition to the elapsed call time for audio and video conferences. A panel setup button 704 may be provided for technical support personnel to reconfigure the menus after entering an appropriate password.

FIG. 8 illustrates a representative video cassette recorder submenu for locally or remotely controlling a VCR in a conference room according to one embodiment of the present invention. VCR submenu 800 is preferably displayed within the video output window as described above with reference to FIG. 7. When the VCR submenu is active, it overlays any other submenus or video output. The submenu is closed via an associated button 802. VCR control submenu 800 preferably includes separate areas for control of play functions 804 and record functions 806. As illustrated, play functions 804 may include stop, pause, play, rewind, and fast forward. Record functions 806 may correspond to a second VCR within the conference room such that a tape can be copied from the first VCR to the second VCR. In the example illustrated, record controls 806 are used to record a session on a second VCR using record and stop buttons.

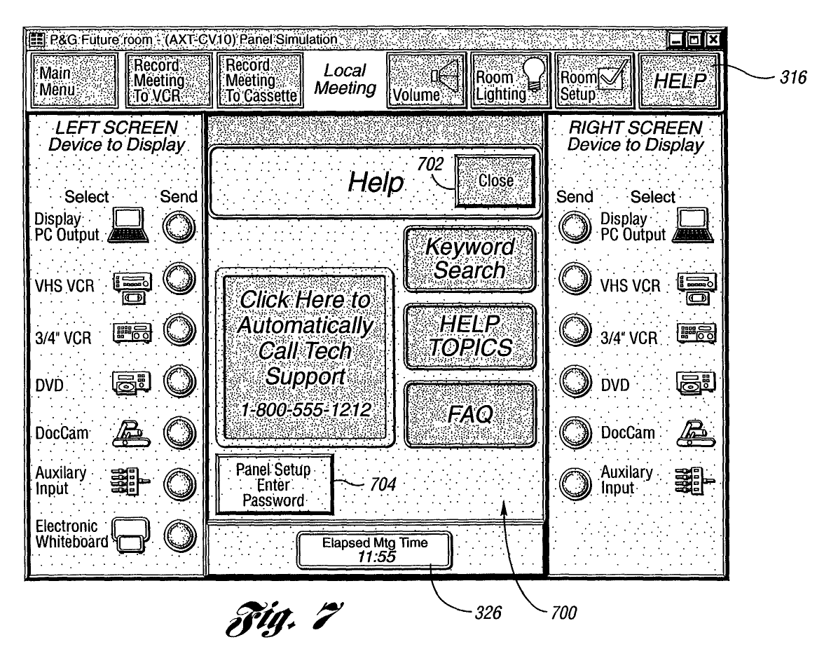

Referring now to FIG. 9, a representative digital video disk (DVD) control menu for locally or remotely controlling a DVD device according to one embodiment of the present invention is shown. DVD control submenu 900 preferably includes an area for playback functions 902 and/or cursor control functions 904. As illustrated, playback buttons 902 may include stop, pause, play, skip forward, skip reverse, review, and fast forward. Cursor controls 904 preferably include controls to move a cursor in four directions in addition to a menu command and enter command.

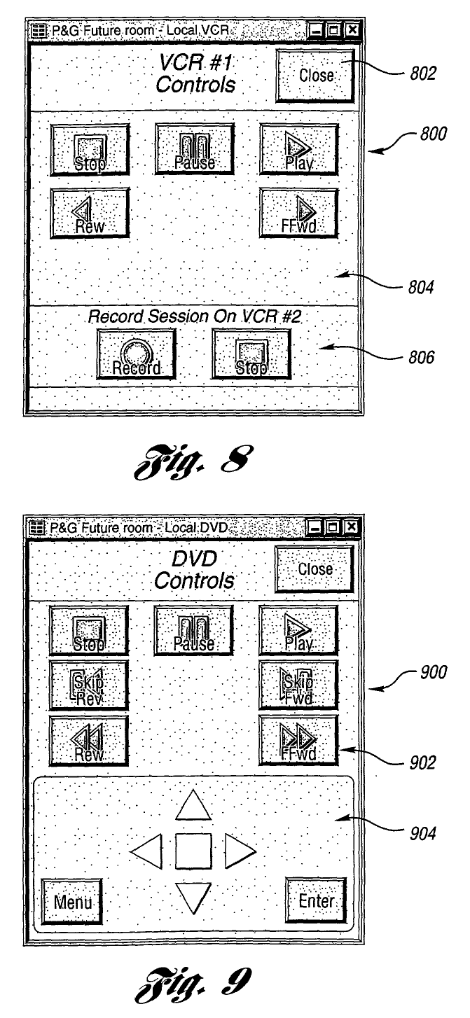

FIG. 10 illustrates a representative compact disk (CD) submenu for locally or remotely controlling a CD device according to one embodiment of the present invention. CD control submenu 1000 may include a power control 1002 in addition to playback controls 1004. In this example, playback controls include stop, pause, play, skip forward, skip reverse, review, and fast forward. As with the other submenus illustrated, the particular configuration may vary by application. However, according to the present invention, the user interface should contain as many common features as possible to facilitate usability.

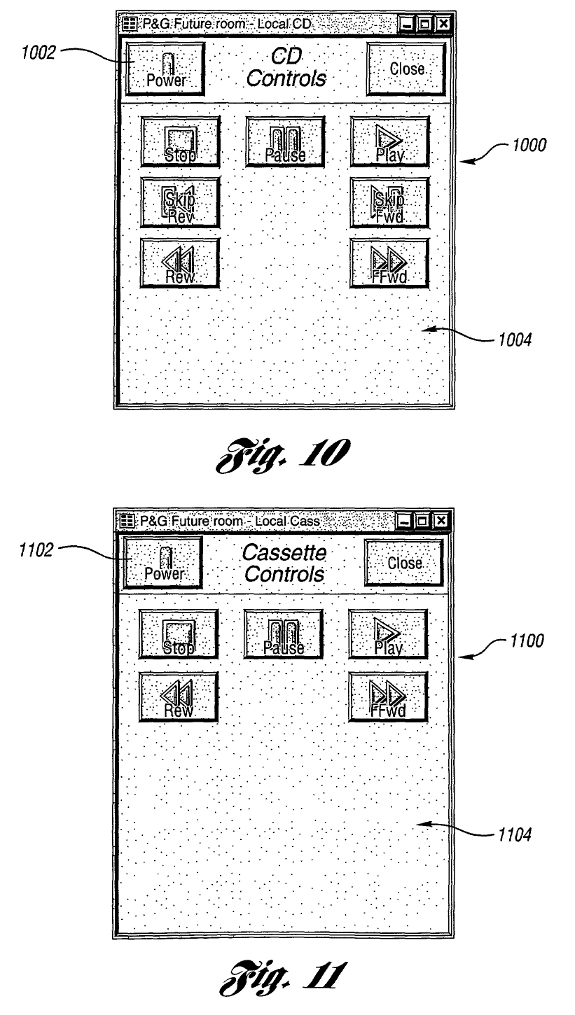

FIG. 11 illustrates a representative audio cassette control submenu for locally or remotely controlling an audio cassette device according to one embodiment of the present invention. Submenu 1100 may include a power button 1102 in addition to playback controls 1104. This submenu is displayed in the video output area of the currently selected type of conference similar to those described above. In this example, the playback controls include stop, pause, play, rewind, and fast forward.

FIG. 12 illustrates a representative document camera control submenu for locally or remotely controlling a conference room camera according to one embodiment of the present invention. Document camera control submenu 1200 is displayed when a user selects document camera from a local meeting or video conference meeting menu. In this example, menu 1200 includes a power button 1202, presets 1204, zoom control 1206, and focus control 1208. Using preset control 1204, the user can define and save up to four presets for camera position, zoom, and focus to facilitate rapid display of particular positions and corresponding documents within the conference room.

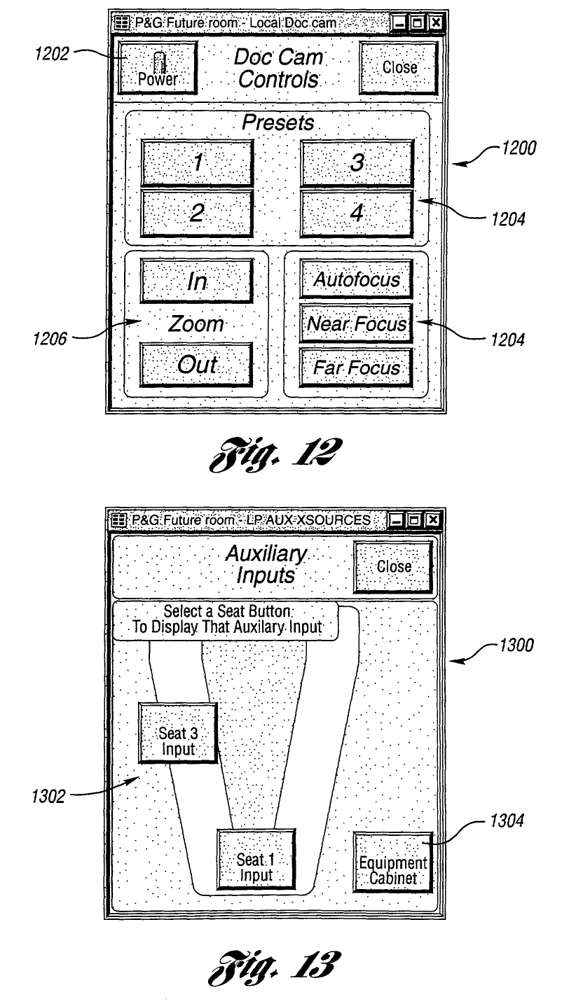

FIG. 13 illustrates a representative auxiliary input control submenu for locally or remotely controlling auxiliary equipment according to one embodiment of the present invention. Auxiliary input submenu 1300 allows the user to connect equipment or devices which are not already listed in any of the menu selections. Submenu 1300 is displayed when a user selects the auxiliary input button from the local meeting, audio conference, or video conference menus. In this example, only three locations exist to connect an auxiliary input corresponding to seats 1 and 3, indicated generally by reference numeral 1302, and an equipment closet, represented by reference numeral 1304.

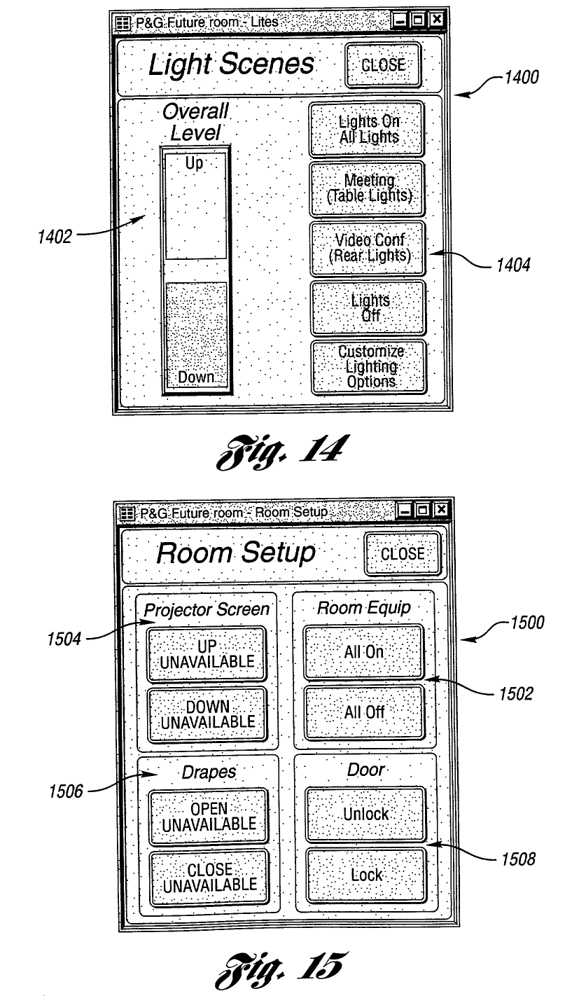

A representative room light control submenu for locally or remotely controlling the ambient lighting in the conference room according to one embodiment of the present invention is illustrated in FIG. 14. Light control submenu 1400 allows the user to select and control available lighting within the conference room. As illustrated, an overall level slide bar 1402 is provided in addition to various control buttons 1404. In this example, control buttons may be used to turn all lights on, table lights on, rear lights on, lights off, or to customize lighting options. The customized lighting options button allows the user to select which lights and the associated lighting level for various situations represented by each of these buttons and to save those settings. For example, the user may select a customized level for each of the buttons corresponding to all lights on, reading lights, video conference lights, etc. Subsequent selection of those buttons will light the room based on the saved settings. After a meeting, the user can reset the system to the default lighting configuration and levels.

FIG. 16 illustrates a representative room setup menu for locally or remotely controlling various conference room devices according to one embodiment of the present invention. As such, room setup submenu 1500 allows a user to raise and lower a projector screen, open or close window coverings, turn all room equipment on or off, and lock or unlock the door. This submenu is particularly useful for support personnel to remotely cycle equipment power in the event of a problem or to prepare the equipment before a meeting. Similarly, the door lock and unlock buttons are for permitting access to the conference room prior to a meeting and locking the door after a meeting. Of course, users are able to open the door from inside the conference room as any time. In this example, submenu 1500 may be used to control power for all of the conference room equipment via menu 1502. Likewise, menus are provided to control a projector screen 1504, window coverings 1506, and to control physical access 1508 to the conference room via a door lock, for example. However, in this example, control of a projector screen and window coverings is unavailable as indicated by the text within the associated buttons as well as the menus being “grayed out.”

FIG. 16 illustrates a representative computer output selection menu for locally or remotely controlling the display of a local computer's output according to one embodiment of the present invention. Submenu 1600 includes buttons for a selection of various locations within the conference room as represented by reference numeral 1602. Likewise, a menu may include selection of a resident work station 1604 depending upon the particular application. The local computer is selected for display in a similar fashion the other conference room devices. For example, a user would connect his or her computer via an appropriate video cable to the local conference room control computer. Selection of the appropriate position on submenu 1600 then displays or transmits the local computer display to the remote location.

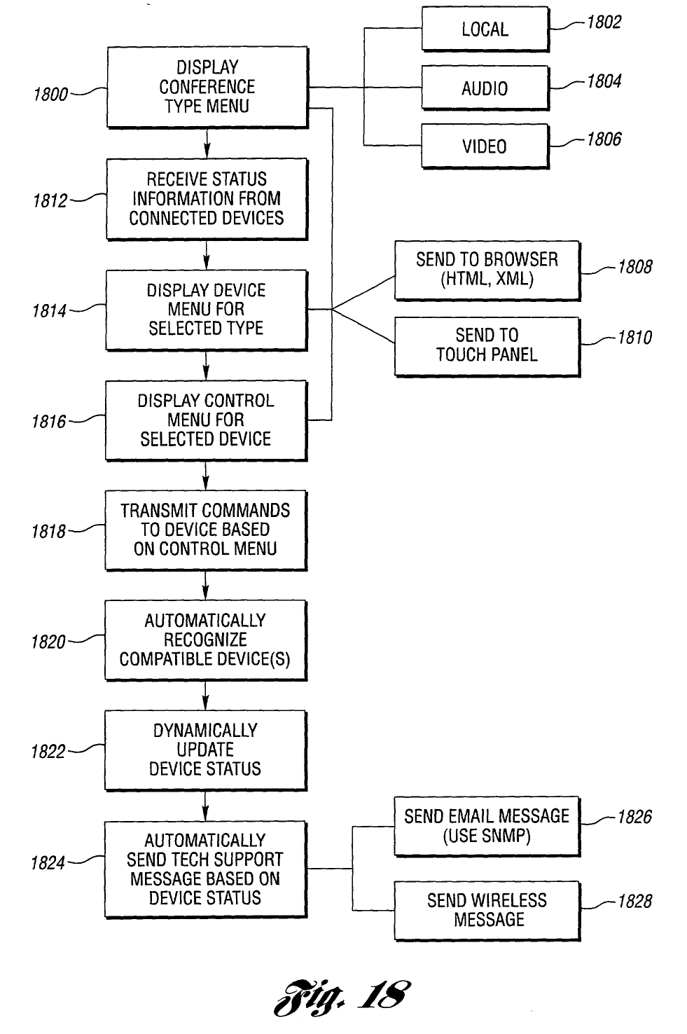

FIG. 17 illustrates a representative camera preset control menu for locally or remotely controlling a videoconferencing camera according to one embodiment of the present invention. Submenu 1700 includes a number of buttons corresponding to various seats 1702, table 1704, etc. Camera present submenu 1700 allows users to preset the camera pan, tilt, and zoom settings to appropriately display all those at the table, or to feature a particular speaker at one of the chair positions. This facilitates proper positioning of the camera via a single button or key press during a conference.

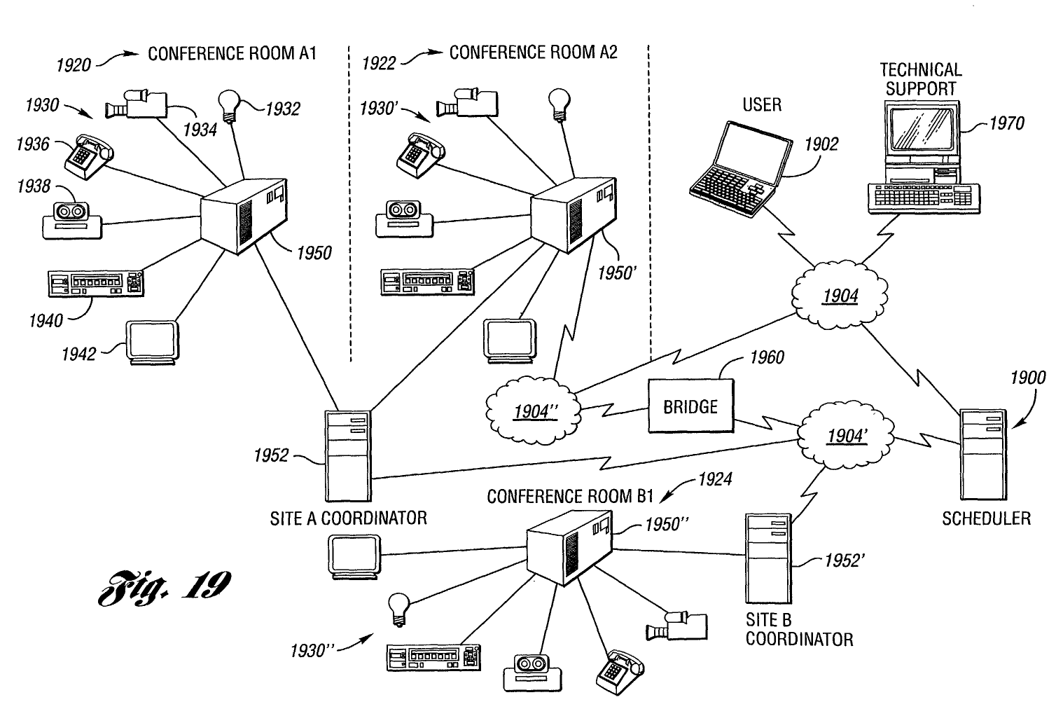

Referring now to FIG. 18, a flowchart illustrating operation of one embodiment of a system and method for remotely controlling a computer according to the present invention is shown. As will be appreciated by one of ordinary skill in the art, the flowchart illustrated in FIG. 18 may represent any of a number of known processing strategies such as event-driven, interrupt-driven, multi-tasking, multi-threading, and the like. Similarly, the present invention is independent of the particular programming language, operating system, or computer platform which may be used to implement the invention. As such, various steps or functions illustrated may be performed in the sequence illustrated, in parallel or in some cases omitted altogether. Likewise, the order of processing illustrated is not necessarily required to achieve the objects, features, and advantages of the invention, but is provided for ease of illustration and description.

Preferably, the control logic of FIG. 18 is implemented in software which is executed by a microprocessor-based computer, such as a laptop or desktop computer, represented generally by computer 108 of FIG. 1. Of course, various portions or functions of the control logic may be implemented in software, hardware, or a combination of software and hardware. The flowchart of FIG. 18 illustrates one “loop” and its operations are preferably repeated at periodic time intervals or as required by some internal or external event, as known by those of skill in the art. Preferably, control logic represented in FIG. 18 is embodied in data stored on a computer readable storage medium, such as a floppy disk, hard disk, CD-ROM, tape, or other magnetic, optical or combination device. The computer readable storage medium includes data representing instructions executable by a computer to generate commands for remotely controlling a computer according to the present invention.

Block 1800 of FIG. 18 represents displaying a type menu for selection of a type of conference. As described above, the type menu preferably allows users to display menus and controls for only those devices relevant to a selected type of conference. In the described embodiment, conference types include local conference 1802, audio conference 1804, and video conference 1806. The various menus, including the type menu, may be displayed locally via a touch panel 1810 in direct communication with the local control computer, or remotely via a web browser 1808 by transferring appropriately formatted commands to a remote computer using a network, such as the internet. In one embodiment, the local computer transfers commands to a remote computer using HTML or similar language. The local control computer is preferably directly connected to various conference room devices and receives status information from the devices as represented by block 1812. As such, the direct connection is preferably via a two-way or bidirectional protocol such as RS-232 or telnet, for example. The two-way protocol allows the local control computer to automatically determine whether a compatible device has been added to or removed from the conference computer and automatically update its status accordingly on at least one of the menus.

In one embodiment, a “plug-and-play” feature is provided to automatically recognize and configure the system when conference room devices are connected or disconnected from the local computer. As known by those of ordinary skill in the art, automatic detection and configuration of various devices may be accomplished using any of a number of strategies. One common approach is to store a table or database that associates compatible devices with an identification code and selects an appropriate driver. When a compatible device is connected to the computer and powered up, the device sends its identification code to the computer. If the identification code is recognized, the computer can use the database to select the appropriate device driver, which displays the available controls for that device and contains corresponding commands for the device. This allows a common user interface for the conference room device controls without any user intervention such that the need for technical support is minimized or eliminated. If the device identification code is not contained in the database, the computer preferably attempts to automatically obtain device information from the device manufacturer via the internet, for example. Otherwise, a generic driver may be selected which most closely matches the controls for the device or the user may be prompted to insert a floppy disk or CD-ROM with configuration information. Once the device has been recognized and an appropriate driver selected, the status information and device availability may be displayed by the conference room computer.

A device menu having available conference room devices is then displayed for a particular conference room and selected type of conference as represented by block 1814. Of course, some conference rooms may have a dedicated use or purpose or have limited equipment available such that only one menu is desired or necessary. For these applications, the user would not be prompted to select a type of conference. As described above, the conference room devices may include various type of audio/visual and computer equipment (not shown) in addition to devices which control the ambient conditions of the conference room (not shown). The conference room devices preferably include some or all of the following: room lights, a thermostat, a speaker phone, audio equipment, video equipment including at least one camera, window covers, and an access control device such as an automated door lock. A control menu is then displayed corresponding to a selected one of the available devices as represented by block 1816. Depending upon the particular user interface, the control menu may be combined with the available device menu and displayed simultaneously if desired. If a particular device is currently unavailable, the menu will include corresponding text and a graphical indication, such as having an “x” through the icon or being “grayed out” as described above. The control menus may vary based on the device being controlled. The control menu is used to generate a corresponding command for the selected device in response to user input with the commands transmitted to the device from the local conference room computer as represented by block 1818.

As also described above, a system and method for locally or remotely controlling conference room devices using a graphical user interface preferably automatically determines whether a compatible device has been added to or removed form the local conference room computer and updates the status display(s) accordingly as represented by blocks 1820 and 1822. A message may be automatically sent to technical support in response to a user request or a device status as represented by block 1824. These messages may be sent by email as represented by block 1826 or via a wireless device, such as a pager, PDA, or cell phone as represented by block 1828. In one embodiment of the present invention an industry standard protocol, such as the Simple Network Management Protocol (SNMP) may be used to define, monitor, and set traps which identify whether certain conditions or criteria have been met, or when limitations are about to be exceeded. SNMP can perform various actions based on the predefined conditions. For example, a trap may be used to monitor the useful or rated life of a projector bulb and automatically generate an email message when a projector bulb is approaching its rated life. Likewise, if the bulb fails prematurely, SNMP can be used to send an urgent message, page, etc. as described above.

FIG. 19 illustrates a representative configuration for remotely accessing conference room devices using a scheduler according to one embodiment of the present invention. Scheduler 1900 is preferably implemented as a website having menus and/or forms which may be remotely accessed by a user computer 1902 to schedule facilities and equipment for a conference. Scheduler 1900 may be accessed via a network, represented generally by reference numeral 1904 which may be a local or wide area network, such as a corporate intranet or the internet, respectively. Scheduler 1900 includes a database of available facilities, such as conference rooms 1920 (A1), 1922 (A2), 1924 (B1) and associated equipment, represented generally by reference numeral 1930, which may include ambient lighting 1932, camera 1934, speaker phone 1936, VCR 1938, audio equipment 1940 and monitor 1942, for example. Conference room devices 1930 are directly connected via a first interface to a local conference room control computer 1950, which may be directly connected to a site coordinator computer 1952 via a second interface. Alternatively, or in combination, local conference room control computers 1950, 1950′, 1950″ may be connected to site coordinator computer 1952 via a local or wide area network 1904′. Similarly, a bridge 1960 may be connected to local conference room control computers 1950, 1950′, 1950″ directly via a network 1904, 1904′, 1904″ or indirectly via corresponding site coordinator computers 1952, 1952′ depending upon the particular application. Bridge 1960 may provide audio and/or video conferencing connections between or among conference rooms located at the same site (conference rooms 1920, 1922 for example) and/or remotely located conference rooms (such as conference room 1924 for example). Bridge 1960 is preferably operated by a third party that provides automatic remote control and/or scheduling as described in greater detail below. One or more remotely located technical support computers 1970 may be connected via network 1904 to scheduler 1900, site coordinator computers 1952, 1952′, and/or local conference room control computers 1950, 1950′, and 1950″ to provide remote troubleshooting and dispatch of technicians to conference rooms if necessary.

In operation, remote user 1902 logs into a website via network 1904 hosting scheduler 1900 to determine availability and schedule conference room facilities and devices. Scheduler 1900 includes a database of available facilities 1920, 1922, 1924 and associated conference room devices 1930, 1930′, 1930″. The available conference room devices may be periodically or dynamically updated as devices are added or removed from particular conference rooms as described above. After selecting a date, time, location, and devices for a conference, scheduler 1900 may perform a quality check or audit of scheduled equipment to assure that scheduled equipment is operational. For example, scheduler 1900 may send appropriate commands to conference room devices to perform a power-on test to detect burnt out bulbs, etc. Any problems may be automatically reported to technical support computers 1970 for appropriate remedial action with priority based on the scheduled conference date and type of problem, for example.

Depending upon the particular application, scheduler 1900 may communicate scheduling information relative to the facilities and devices to site coordinator computers 1952, 1952′, or may communicate directly with local conference room control computers 1950, 1950′, and 1950″. If an audio or video conference is requested, scheduler 1900 may communicate directly with bridge 1960 to schedule or reserve appropriate resources for the number and type (video/audio) of connections that were scheduled by user 1902. Scheduler 1900 or bridge 1960 may then initiate the telephone/video calls a t the scheduled time or may allow users to initiate the calls using the reserved bridge connections. Similarly, scheduler 1900 preferably communicates with site coordinator computers 1952, 1952′ to control the room lighting, temperature, and unlock doors prior to the scheduled conference time so that each conference room is ready for users to walk in and immediately begin the scheduled conference.

As described above, the representative system illustrated in FIG. 19 allows immediate technical support via remotely located technical support computers 1970. Some technical difficulties may automatically generate messages for appropriate action by technicians. Alternatively, users may call technical support via a menu option on the user interface, for example. Technicians may use technical support computers 1970 to remotely access control computers 1950 to facilitate troubleshooting. For example, in a videoconferencing application, technicians have the ability to remotely view conference room 1920 using camera 1934, which preferably provides video image of the remaining conference room devices 1930. In addition, the output signal or feed from additional videoconferencing cameras may be remotely accessed to aid in determining the source of any problem. Technicians may then assist users in operating or troubleshooting equipment and dispatch additional help if necessary.

As described above, the present invention solves a number of problems associated with use of conference room devices while allowing local and/or remote control and monitoring of equipment using an intuitive graphical user interface which is consistent across various brands of audio/video equipment. The departmentalized approach provides users with real-time status information of relevant equipment corresponding to a particular type of conference to minimize confusion and increase usability.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for controlling conference room devices connected to a first computer, the method comprising:
receiving status information from the conference room devices connected to the first computer;
displaying a device menu of available devices for a particular conference room;
displaying a control menu to control at least one of the available devices; and
transmitting commands to a selected one of the available devices to control the selected device in response to user input.

2. The method of claim 1 wherein the devices include at least one of an ambient lighting control, ambient temperature control, a speaker phone, audio equipment, video equipment, window coverings, and a physical access control.

3. The method of claim 1 wherein the device menu and the control menu are displayed simultaneously.

4. The method of claim 1 wherein the device menu and the control menu are displayed on a common screen.

5. The method of claim 1 further comprising displaying a type menu for selection of a type of conference.

6. The method of claim 5 wherein the step of displaying a device menu comprises displaying a device menu of available devices corresponding to the type of conference selected.

7. The method of claim 5 wherein the step of displaying a type menu comprises displaying buttons corresponding to at least a local meeting, an audio conference, and a video conference.

8. The method of claim 1 wherein the displaying steps comprise sending formatted menus to a second computer via a computer network wherein the second computer is remotely located from the first computer to allow a remote user to control the conference room devices.

9. The method of claim 1 wherein the displaying steps comprise sending web browser compatible menus to a second computer accessible via the internet.

10. The method of claim 1 further comprising displaying status information for at least one of the conference room devices connected to the first computer.

11. The method of claim 1 further comprising:
automatically determining whether a compatible device has been added to or removed from the conference computer; and
automatically updating a status of the compatible device on at least one of the menus.

12. The method of claim 1 further comprising automatically sending a message to technical support in response to a corresponding device status.

13. The method of claim 12 wherein the step of sending comprises sending an email message.

14. The method of claim 12 wherein the step of sending comprises transmitting a numeric or alphanumeric message to a wireless device indicating a need for technical support.

15. The method of claim 1 further comprising sending a video image of the conference room to technical support personnel.

16. The method of claim 15 further comprising sending a videoconferencing output to technical support personnel in addition to the video image of the conference room to aid in troubleshooting any problems with the conference room devices.

17. The method of claim 1 wherein the step of displaying a control menu comprises displaying a plurality of buttons including at least buttons corresponding to play, pause, stop, forward, and reverse.

18. The method of claim 1 wherein the step of displaying a control menu comprises displaying a plurality of buttons including at least buttons corresponding to pan, tilt, and zoom.

19. The method of claim 1 wherein the step of transmitting comprises wirelessly transmitting commands from the first computer to the conference room devices.

20. The method of claim 1 wherein the step of transmitting comprises transmitting commands from the first computer to the conference room devices using a two-way protocol.

21. The method of claim 20 wherein the two-way protocol comprises at least one of RS-232 and telnet.

22. The method of claim 1 wherein the steps of displaying comprise displaying menus for selection by a user via pointing or touching.

23. The method of claim 1 further comprising transmitting a video image of the conference room.

24. The method of claim 1 further comprising selectively transmitting a video image of the conference room to a remotely located technician to facilitate troubleshooting of at least one conference room device.

25. The method of claim 24 further comprising transmitting a videoconferencing feed to a remotely located technician via the first computer to facilitate troubleshooting of at least one conference room device.

26. The method of claim 1 further comprising remotely accessing a video image of the conference room via the first computer to facilitate remote troubleshooting of at least one conference room device.

27. The method of claim 26 further comprising remotely accessing a videoconferencing feed to facilitate remote troubleshooting.

28. The method of claim 1 further comprising:
locally previewing output from a selected one of the devices; and
sending the output to a remote location in response to a send command.

29. The method of claim 1 further comprising displaying a summary screen having status information for all conference room devices associated with a selected conference room.

30. A computer readable storage medium having stored data representing instructions executable by a computer to control conference room devices, the computer readable storage medium comprising:
instructions for receiving status information from the devices;
instructions for displaying a device menu of available devices for a particular conference room;
instructions for displaying a control menu to control at least one of the available devices; and
instructions for transmitting commands to a selected one of the available devices to control the device in response to user input.

31. The computer readable storage medium of claim 30 wherein the devices include at least one lighting, temperature, window coverings, audio equipment, video equipment, and a physical access control device.

32. The computer readable storage medium of claim 30 wherein the instructions for displaying comprise instructions for sending formatted menus to a second computer via a computer network wherein the second computer is remotely located from the first computer to allow a remote user to control the conference room devices.

33. The computer readable storage medium of claim 30 wherein the instructions for displaying comprise instructions for sending web browser compatible menus to a second computer accessible via the internet.

34. The computer readable storage medium of claim 30 further comprising:
instructions for automatically determining whether a compatible device has been connected or disconnected such that the compatible device is available or unavailable, respectively; and
instructions for automatically updating a status of the compatible device on at least one of the menus based on the device being connected to or disconnected from the computer.

35. The computer readable storage medium of claim 30 further comprising instructions for automatically sending a message to technical support in response to a corresponding device status.

36. The computer readable storage medium of claim 30 wherein the instructions for displaying a control menu comprise instructions for displaying a plurality of buttons including at least buttons corresponding to pan, tilt, and zoom.

37. The computer readable storage medium of claim 30 wherein the instructions for transmitting comprise instructions for wirelessly transmitting commands to the conference room devices.

38. The computer readable storage medium of claim 30 wherein the instructions for transmitting comprise instructions for transmitting commands to the conference room devices using a two-way protocol.

39. The computer readable storage medium of claim 38 wherein the two-way protocol comprises at least one of RS-232 and telnet.

40. The computer readable storage medium of claim 30 wherein the instructions for displaying comprise instructions for displaying menus via a touch panel directly connected to the computer.

41. The computer readable storage medium of claim 30 further comprising instructions for transmitting a video image of the conference room to a remote location.

42. The computer readable storage medium of claim 30 further comprising instructions for displaying a type menu for selection of a type of conference.

43. The computer readable storage medium of claim 42 wherein the instructions for displaying a device menu display a device menu of available devices corresponding to a selected type of conference.

44. The computer readable storage medium of claim 42 wherein the instructions for displaying a type menu comprise instructions for displaying buttons corresponding to at least a local meeting, an audio conference, and a video conference.

45. The computer readable storage medium of claim 30 further comprising:
instructions for locally previewing output from a selected one of the devices; and
instructions for sending the output from the selected one of the devices to a remote location in response to a send command.

46. The computer readable storage medium of claim 30 further comprising instructions for displaying a summary screen having status information for all conference room devices associated with a particular conference room.

47. A system for controlling conference room devices, the system comprising:
a computer connected to a computer network accessible by at least one remotely located computer;
a device connected to the computer for displaying menus and receiving input from users in the conference room;
a camera directly connected to the computer, the camera receiving commands from the computer including at least zoom, tilt, and pan commands, and sending status information to the computer including at least on and off;
a telephone in communication with the computer for dialing telephone numbers and providing audio communication between the conference room and a remote location;
wherein the computer generates commands to display menus and receive commands via the touch panel including a device menu showing available devices and corresponding control menus.

48. A system for remotely accessing conference room devices, the system comprising:
a computer having a first interface for connecting the conference room devices and a second interface for remotely accessing the computer, wherein the computer transmits information via the second interface indicative of available conference room devices connected to the first interface for a selected conference room.

49. The system of claim 48 wherein the computer receives status information from at least one conference room device via the first interface and transmits status information for the at least one conference room device via the second interface.

50. The system of claim 48 wherein the computer transmits commands via the first interface to control at least one conference room device.

51. The system of claim 48 wherein the computer receives a command from a second computer via the second interface and transmits a corresponding command via the first interface to control at least one conference room device.

52. The system of claim 48 wherein the conference room devices include a videoconferencing camera, a videoconferencing monitor, and a conference room camera connected to the computer via the first interface, wherein the computer selectively transmits images from the conference room camera, which is remotely controllable via the second interface, to facilitate remote troubleshooting of the videoconferencing camera and/or monitor by a technician.

53. The system of claim 52 wherein the computer selectively transmits images from the videoconferencing camera via the second interface to a remotely located technician to facilitate troubleshooting of the videoconferencing camera and/or monitor.

54. A method for controlling conference room devices associated with a conference room, the conference room devices connected to a first computer, the method comprising:
receiving a scheduling request for the conference room including a date and time; and
automatically generating a request to control at least one of the conference room devices via the first computer based on the scheduled date and time.

55. The method of claim 54 wherein the conference room devices include a physical access control device and wherein the step of automatically generating a request comprises automatically generating a request to control the physical access control device to allow access to the conference room based on the scheduled date and time.

56. The method of claim 54 wherein the scheduling request includes a request for use of video and/or audio conferencing devices, the method further comprising:
automatically requesting connections from a bridge provider based on the date and time.

57. The method of claim 54 wherein the scheduling request identifies at least one conference room device, the method further comprising:
automatically determining status of the at least one conference room device; and
automatically contacting technical support if the status of the at least one conference room device indicates a problem.
